(19) United States
(12) Patent Application Publication
(10) Pub. No.: US 2025/0274920 A1
(43) Pub. Date: Aug. 28, 2025

(54) BANDWIDTH COMBINATION SET SIGNALING

(71) Applicant: T-Mobile Innovations LLC, Overland Park, KS (US)

(72) Inventors: William M. SHVODIAN, McLean, VA (US); Egil Arnfinn Gronstad, Encinitas, CA (US)

(21) Appl. No.: 19/063,660

(22) Filed: Feb. 26, 2025

Related U.S. Application Data
(60) Provisional application No. 63/558,115, filed on Feb. 26, 2024.

(51) Int. Cl. H04W 72/0453; H04L 5/00

(52) U.S. Cl. CPC H04W 72/0453; H04L 5/001

(57) ABSTRACT

A system and method for signaling bandwidth combination set (BCS) values in a wireless communication network are disclosed. Signaling may be used by a radio access network (RAN) to signal whether it supports a particular BCS, its highest-order supported BCS, or a list of supported BCS values. In response to the UE receiving an indication of the RAN's capabilities, the UE may communicate a commonly-supported BCS to the RAN. Accordingly, the disclosed approach enhances CA negotiation and improves system performance by preventing BCS mismatches and lowering UE signaling overhead by allowing the UE to report only combinations that the RAN can support. The described techniques apply to cellular networks and other wireless technologies, such as Wi-Fi multi-link operation (MLO).

### CROSS-REFERENCE TO RELATED APPLICATIONS

This application claims the benefit of U.S. Provisional Patent Application No. 63/558,115, filed on Feb. 26, 2024 the entirety of which is incorporated herein by reference.

### SUMMARY

The present disclosure is directed to user equipment (UE) signaling bandwidth combination set capabilities, substantially as shown and/or described in connection with at least one of the Figures, and as set forth more completely in the claims.

In modern communication environments, UEs are often capable of aggregating two or more component carriers in order to achieve higher throughput. In 5G, information about the specific carrier aggregation capabilities of the UE is accomplished by reporting its bandwidth combination set (BCS) capabilities to a radio access network (RAN) node. Variations in network support for BCS values can lead to interoperability issues, limiting optimal CA configurations. To address this, the disclosure introduces BCS signaling between the RAN and a UE that enables a UE to indicate CA capabilities that match the capabilities of the RAN.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 illustrates an exemplary computing device for use with the present disclosure;

FIG. 2 illustrates a diagram of an exemplary environment in which implementations of the present disclosure may be employed; and

FIG. 3 depicts a flow diagram of an exemplary method for signaling UE capabilities, in accordance with embodiments described herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like. The term “node” is used to refer to an access point that transmits signals to a UE and receives signals from the UE in order to allow the UE to connect to a broader data or cellular network (including by way of one or more intermediary networks, gateways, or the like)

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules-in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, wireless communication networks, such as those operating under the Fifth Generation (5G) New Radio (NR) standard, support carrier aggregation (CA) to enhance data throughput by combining multiple component carriers. To facilitate CA, a user equipment (UE) reports its highest order band combinations and one or more bandwidth combination set (BCS) index values to indicate its supported aggregation configurations. The radio access network (RAN), using this information, determines an appropriate CA for the UE and assigns it to the UE. The BCS indexes are referenced against predefined sets of component carrier bandwidths and frequency bands specified in 3GPP technical standards. The successful configuration of CA depends on the network's ability to interpret and apply the reported BCS indexes. In some cases, different BCS indexes only define different component carrier bandwidths (e.g., the channel bandwidth of band n41 in BCS 1 includes 70 MHz, whereas BCS 0 does not include the 70 MHz channel bandwidth option for band n41). In other cases, different BCS indexes additionally or alternatively comprise different capability signaling (e.g., BCS5 has additional signaling information elements (IEs) that can be used to indicate the minimum bandwidth per band in the combination, the maximum aggregated FDD bandwidth, the maximum aggregated TDD bandwidth, and/or total overall bandwidth).

Conventionally, a UE signals its capability information during initial registration or when requested by the network. This capability signaling typically includes one or more feature sets, each of which defines a set of supported radio parameters, including MIMO configurations, modulation schemes, power class settings, band combination capabilities, and a BCS index. When configuring CA, the network selects a feature set and applies the corresponding BCS indexes to determine the valid aggregation configurations. Traditionally, new BCS values were infrequently added by standards bodies (e.g., 3GPP standardization of the 5G protocol); however, it is contemplated a more iterative approach to BCS deployment may be needed in the future in order to support the addition of new capability signaling information elements driven by UE manufacturers or mobile network operators. Once UEs are manufactured to support a particular BCS (e.g., signaling IEs), it may not be possible to support subsequent BCS changes. In other words, it is increasingly possible in the future that a UE and the RAN may have different carrier aggregation capabilities.

Unlike conventional solutions, the present disclosure is directed to systems and methods that mitigate carrier aggregation capability mismatches between a UE and a RAN. In aspects, a UE may be configured to support a first BCS (e.g., BCS 5); the UE may thus be configured to signal one or more CA capabilities (e.g., maximum aggregated FDD bandwidth, maximum aggregated TDD bandwidth, and/or maximum aggregated total (FDD+TDD) bandwidth). If there is agreement in the future about a new capability signaling (e.g., the number of MIMO layers supported by a UE, supported modulation, supported coding or duplex schemes), then a second BCS (e.g., BCS 6) could be subsequently created and standardized. Additional modifications to channel bandwidths, signaling, or any other parameter relevant to CA session creation may then be applied to a yet subsequent BCS (e.g., BCS 7). Further, new signaling may be used by the RAN to signal whether it supports a particular BCS (e.g., whether the RAN supports BCS 5), its highest-order supported BCS, or a list of supported BCS values. When the UE receives an indication of the RAN's capabilities, it is significantly more likely to be assigned an appropriate CA configuration because the UE is able to communicate a commonly-supported BCS to the RAN. Accordingly, the disclosed approach enhances CA negotiation and improves system performance by preventing BCS mismatches and lowering UE signaling overhead by allowing the UE to report only combinations that the RAN can support.

Accordingly, a first aspect of the present disclosure is directed to a base station in a wireless network environment. The base station comprises one or more antennas configured to wirelessly communicate with one or more UEs. The base station further comprises one or more computer processing components configured to perform operations. The operations comprise communicating, to a first UE and using the one or more antennas, a bandwidth combination set (BCS) capability. The operations further comprise receiving, from the first UE and using the one or more antennas, one or more carrier aggregation (CA) capability messages from the first UE. The operations further comprise based on the one or more CA capability messages, establishing a CA session by allocating a plurality of component carriers to the first UE.

Another aspect of the present disclosure is directed to a method for managing carrier aggregation sessions in a wireless network environment. The method comprises communicating, to a first UE, a bandwidth combination set (BCS) capability. The method further comprises receiving, from the first UE, one or more carrier aggregation (CA) capability messages from the first UE. The method further comprises based on the one or more CA capability messages, establishing a CA session by allocating a plurality of component carriers to the first UE.

Another aspect of the present disclosure is directed to a non-transitory computer readable media comprising instructions that, when executed by one or more computer processing components, cause the one or more computer processing components to perform operations. The operations comprise communicating, to a first UE, a bandwidth combination set (BCS) capability. The operations further comprise receiving, from the first UE, one or more carrier aggregation (CA) capability messages from the first UE. The operations further comprise based on the one or more CA capability messages, establishing a CA session by allocating a plurality of component carriers to the first UE.

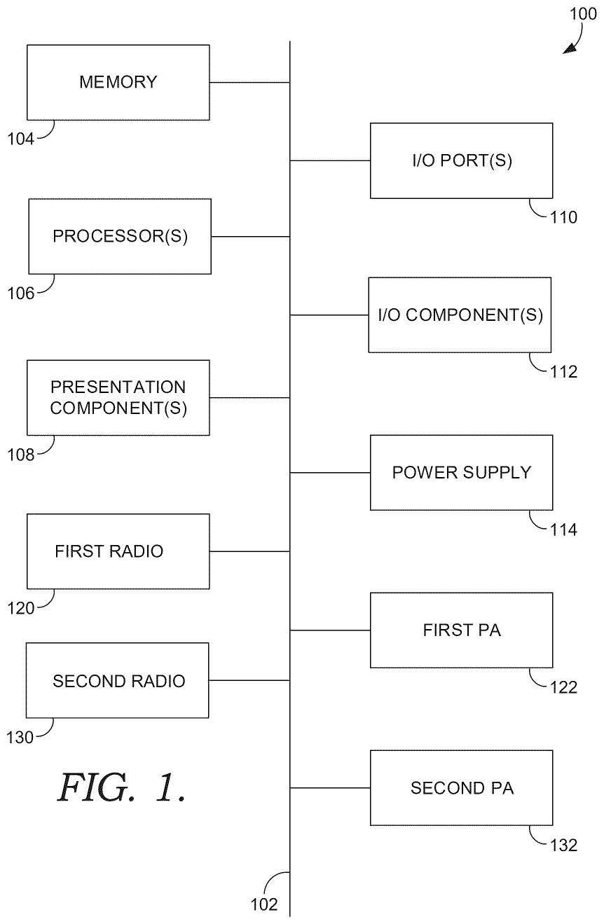

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device. The computing device 100 may take the form of a wireless access device that acts as a more localized and consolidated access point that provides end user wireless devices access to a broader network; examples of wireless access devices include fixed wireless access (FWA) devices and mobile hotspots. The computing device 100 may take the form of a mobile device, used herein to refer to categories of often-portable devices that utilize a wireless connection to a broader network and are typically configured for direct human interaction and personal computing tasks; examples of mobile devices include smartphones, tablets, extended reality (XR) device (e.g., augmented reality (AR), virtual reality (VR), and mixed reality (MR)), computers (e.g., laptops and PCs), wearable devices (e.g., smartwatches, fitness tracker), electronic readers (i.e., an e-book reader or digital book reader), portable media player, handheld GPS/location device, digital camera, gaming console, and digital voice recorders. The computing device may take the form of a connected vehicle that integrates advanced communication and computing technologies to interact with other devices and networks, encompassing vehicle to vehicle (V2V) communications, vehicle to infrastructure (V2I) communications, and/or vehicle to everything (V2X) communications, and that utilizes a wireless connection to support telematics, infotainment systems, over the air updates, vehicle health monitoring, and/or enhanced navigation; examples of connected vehicles include automotive, locomotive, airborne, and cargo (e.g., train car, semi-trailer) systems. The computing device 100 may take the form of an Internet of Things (IoT) device, a physical object embedded with sensors, software, or other technologies that enable them to collect, exchange, and act on data using an internet connection, which allows them to perform automated, decision-making or, other content-provision tasks; examples of IoT devices include smart home devices (e.g., smart thermostats, smart lights, power supply/management systems, and smart security systems), connected appliances (e.g., smart refrigerators), health monitoring devices (e.g., blood pressure monitor, glucose monitor), industrial devices (e.g., smart sensors, predictive maintenance systems), and agricultural devices (e.g., soil, environmental, or growth sensors).

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and a second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, 802.11, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, NR, VoLTE, or other VOIP communications. In aspects, the first radio 120 and the second radio 130 may be configured to communicate using the same protocol but in other aspects they may be configured to communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may be configured to communicate with one or more other computing devices according to a local area communication protocol (e.g., IEEE 802.11 series, Bluetooth, NFC, z-wave, or the like).

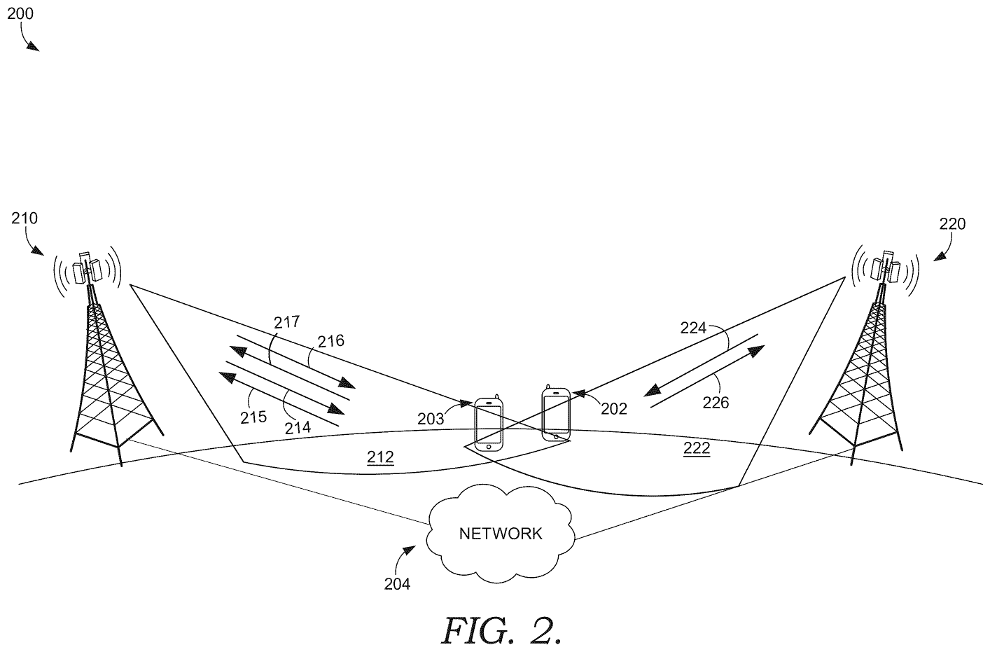

Turning now to FIG. 2, an exemplary network environment is illustrated in which implementations of the present disclosure may be employed. Such a network environment is illustrated and designated generally as network environment 200. At a high level the network environment 200 comprises a UE 202, a first base station 210, a second base station 220, and a network 204. It should be understood that more than one of each component is expressly conceived as being within the bounds of the present disclosure; for example, the network environment 200 may comprise additional base stations, additional UEs, and/or additional networks. Similarly, though certain objects of network environment 200 are illustrated in a certain form, it should be understood that they may take other forms; for example, even though the UE 202 is illustrated as a cellular phone, a UE suitable for implementations with the present disclosure may be any computing device having any one or more aspects described with respect to FIG. 1, and even though the first base station 210 and the second base station 220 are illustrated as macro cells mounted on towers, a base station suitable for use with the present disclosure may be terrestrial or extra-terrestrial (e.g., a satellite of a satellite radio access network) and may be of any scale desirable by a mobile network operator (MNO) (e.g., a small cell, pico cell, relay, and the like).

The network environment 200 includes one or more base stations, represented by the first base station 210 and the second base station 220. Each of the first base station 210 and the second base station 220 are connected to the network 204 (e.g., a MNO core network) and are configured to wirelessly communicate with one or more UEs, such as the UE 202. The first base station 210 is configured to transmit one or more component carriers in the downlink to a first coverage area 212 and to receive one or more component carriers in the uplink from a UE located within the first coverage area 212. As such, the first base station 210 may be configured to transmit a first downlink component carrier 214 and a second downlink component carrier 216, and to receive a first uplink component carrier 215 and a second uplink component carrier 217. In aspects, each of said component carriers may be characterized by their utilization of frequency domain duplexing (FDD) or time domain duplexing (TDD); for example, the first downlink component carrier 214 may be FDD and the second downlink component carrier 216 may be TDD (in another aspect, both may be FDD or both may be TDD). The second base station 220 may be similarly configured to transmit a third downlink component carrier 224 to a second coverage area 222 and receive a third uplink component carrier 226 from a UE located in the second coverage area 222. In aspects, each of the first downlink component carrier 214, the first uplink component carrier 215, the second downlink component carrier 216, and the second uplink component carrier 217 may be FDD signals, and each of the third downlink component carrier 224 and the third uplink component carrier 226 may be TDD signals. Though illustrated as having a single cell so as not to obfuscate the present disclosure, it should be understood that the first base station 210 may utilize a plurality of different cells to communicate signals to the UE 202; thus, in aspects, each of the first downlink component carrier 214 and the first uplink component carrier 215 are communicated between the UE 202 and a primary cell, each of the second downlink component carrier 216 and the second uplink component carrier 217 are communicated between the UE 202 and a first secondary cell, and each of the third downlink component carrier 224 and the third uplink component carrier 226 are communicated between the UE 202 and a second secondary cell.

The simultaneous (or near simultaneous) use of multiple component carriers is generally referred to as carrier aggregation, and may be utilized by the UE 202 in order, for example, to increase the amount of data that may be transmitted or received by the UE 202. The UE 202 comprises one or more components that, together, may be said to comprise a baseband processor, which handles tasks such as demodulation, decoding, error correction, and channel equalization. Relevant to the present disclosure, the UE 202 has a set of capabilities associated with what frequencies and bandwidths the UE 202 can process for each individual component carrier. The UE may also have a total number of component carriers it can process and a total aggregated bandwidth it can process across all component carriers.

The present disclosure relates to systems and methods for user equipment (UE) capability signaling in a wireless communication network, particularly for bandwidth combination set (BCS) signaling in the context of carrier aggregation (CA). Carrier aggregation allows the UE 202 to simultaneously utilize multiple component carriers (e.g., first downlink component carrier 214, the second downlink component carrier 216, and the third downlink component carrier 224) across one or more frequency bands, increasing data rates and improving network efficiency. However, not all networks and UEs support the same aggregation configurations, leading to compatibility issues when the UE 202 reports capabilities that are not recognized by a base station, such as the first base station 210 or the second base station 220.

One key aspect of CA capability signaling is the bandwidth combination set (BCS). A BCS defines specific sets of component carrier bandwidths and frequency bands that the UE can aggregate. Each BCS value corresponds to a predefined aggregation configuration that dictates which frequency bands and carrier bandwidths the UE may be allocated in a CA session, and in some cases, what signaling is used. The network references the reported BCS index to determine valid carrier aggregation configurations when assigning frequency resources to the UE 202. Without proper BCS signaling, the network may be unable to configure CA effectively, leading to suboptimal spectrum utilization and reduced throughput. In some cases, different Bandwidth Combination Set (BCS) values define distinct configurations of aggregated channel bandwidth; for example, a first BCS may specify different channel bandwidth capabilities for one or more bands than a second BCS. In other aspects, different BCS values may correspond to distinct information elements communicated between the User Equipment (UE) and the Radio Access Network (RAN). In an example, a first BCS may include one or more information elements that assist in CA session establishment, such as minimum bandwidth per band within the band combination, maximum aggregated frequency division duplex (FDD) bandwidth, maximum aggregated time division duplex (TDD) bandwidth, and maximum total aggregated bandwidth across all component carriers; whereas, a second BCS may not include one or more of said information elements.

BCS values are signaled by the UE 202 as part of a feature set, which groups various capability parameters together. A feature set defines the UE 202's supported CA configurations, including modulation schemes, multiple-input multiple-output (MIMO) layer support, maximum aggregated bandwidth, and power class settings. Each feature set typically contains one or more BCS values, which the network uses to determine supported CA configurations. Conventionally, the UE 202 reports its highest-order CA capabilities, which comprises the most up-to-date or highly capable BCS that the UE 202 supports with the most component carriers, and associated band combination capabilities. Band combination capabilities define the specific frequency bands and bandwidths that a UE can aggregate using CA.

In aspects of the present disclosure, a RAN (e.g., the first base station 210 and/or the second base station 220) signals its BCS capabilities to one or more UEs, such as the first UE 202 and/or the second UE 203. In a first signaling aspect, the RAN may indicate only its highest supported BCS value. Under this signaling scenario, the UE may infer that all lower-order BCS values are supported as well. Alternatively, in another signaling aspect, the RAN explicitly communicates all supported BCS values individually, clearly identifying each specific BCS value it can utilize (e.g., BCS 0, 1, 2, 3, and 4) and is silent regarding BCS values it does not support. In yet another signaling aspect, the RAN may communicate a plurality of BCS values and explicitly indicate, among the plurality, which are supported and which are not. For example, the RAN could signal explicit support for BCS 0, BCS 1, BCS 2, and BCS 4 while additionally indicating explicit non-support for BCS 5.

To illustrate, consider a hypothetical scenario involving the first UE 202 and the second UE 203 interacting with the first base station 210. The first UE 202 may have a maximum BCS capability of BCS 5, while the second UE 203 possesses a more advanced capability, supporting up to BCS 6. Without employing the disclosed improved signaling methods, the second UE might initially signal support only for BCS 6 or communicate information elements specific to BCS 6, elements which might not be comprehensible to the first base station 210 if it does not support this higher-order BCS value (e.g., if the first base station 210 supports up to BCS 5). Consequently, the first base station 210 could ignore or fail to process the capability signaling properly, thereby defaulting to a non-aggregated single-carrier session for the second UE 203. However, using the disclosed enhanced signaling techniques, if the first base station 210 signals its support for a specific BCS value that is lower than the highest capabilities of the second UE 203 (e.g., BCS 5), then upon receiving this explicit indication, the second UE 203 may adjust its capability signaling accordingly, providing CA capability information aligned explicitly with the BCS commonly supported by both the first base station 210 and the second UE 203.

Although the present disclosure describes BCS signaling in the context of cellular communication protocols (e.g., 4G/LTE, 5G/NR, 6G, and the like), similar concepts may be applied to other wireless technologies, such as multi-link optimization (MLO) in Wi-Fi. In such cases, BCS signaling may be used to provide alternative multi-carrier configurations to mitigate capability mismatches between a Wi-Fi access point and a station (Wi-Fi client device). For example, in a Wi-Fi MLO scenario, BCS signaling could allow an access point to communicate carrier aggregation capabilities to a station, such as the UE 202, ensuring that the UE 202 can respond with a capability message that overlaps with the capabilities of the access point. Other protocols or communication standards may implement the present disclosure, as in Wi-Fi and cellular protocols, and no limitation to protocols presently utilizing or developing multi-carrier aggregation sessions is intended.

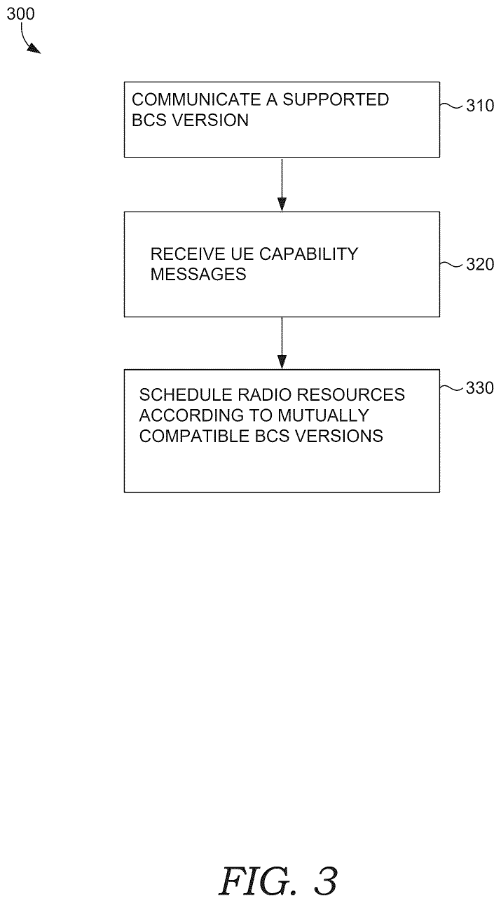

Turning now to FIG. 3, a flow chart is illustrated for managing carrier aggregation sessions in a wireless network environment. At a first step 310, a base station, such as the first base station 210 of FIG. 2, communicates one or more messages indicating a BCS capability of the base station, according to any one or more aspects described herein. At a second step 320, the base station receives one or more CA capability messages from one or more UEs, according to any one or more aspects described herein. At a third step 330, based on the one or more CA capability messages in the second step 320, the base station 210 establishes a CA session by allocating a plurality of component carriers to the one or more UEs, according to any one or more aspects described herein.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A base station in a wireless network environment comprising:
one or more antennas configured to wirelessly communicate with one or more user equipment (UE); and
one or more computer processing components configured to perform operations comprising:
communicating, to a first UE and using the one or more antennas, a bandwidth combination set (BCS) capability;
receiving, from the first UE and using the one or more antennas, one or more carrier aggregation (CA) capability messages from the first UE; and
based on the one or more CA capability messages, establishing a CA session by allocating a plurality of component carriers to the first UE.

2. The base station of claim 1, wherein the BCS capability is further communicated to a second UE, one or more CA capability messages are received from the second UE, and a second CA session is responsively established for the second UE, and wherein the second UE has different BCS capabilities than the first UE.

3. The base station of claim 1, wherein the BCS capability comprises a first BCS and a second BCS, the first BCS being different than the second BCS.

4. The base station of claim 3, wherein the first BCS has the same channel bandwidths as the second BCS and wherein the first BCS has different signaling than the second BCS.

5. The base station of claim 3, wherein the first BCS has the same signaling as the second BCS and wherein the first BCS has different channel bandwidths than the second BCS.

6. The base station of claim 3, wherein the first BCS has different channel bandwidths than the second BCS and wherein the first BCS has different signaling than the second BCS.

7. The base station of claim 1, wherein communicating the BCS capability comprises an indication of the highest BCS supported by the base station.

8. The base station of claim 1, wherein communicating the BCS capability comprises an indication of all BCS values supported by the base station.

9. The base station of claim 1, wherein communicating the BCS capability comprises an indication that the base station supports a portion of a pre-defined plurality of BCS values.

10. A method for managing carrier aggregation sessions in a wireless network environment comprising:
communicating, to a first UE, a bandwidth combination set (BCS) capability;
receiving, from the first UE, one or more carrier aggregation (CA) capability messages from the first UE; and
based on the one or more CA capability messages, establishing a CA session by allocating a plurality of component carriers to the first UE.

11. The method of claim 10, wherein the BCS capability comprises a first BCS and a second BCS, the first BCS being different than the second BCS.

12. The method of claim 11, wherein the first BCS has the same channel bandwidths as the second BCS and wherein the first BCS has different signaling than the second BCS.

13. The method of claim 11, wherein the first BCS has the same signaling as the second BCS and wherein the first BCS has different channel bandwidths than the second BCS.

14. The method of claim 11, wherein the first BCS has different channel bandwidths than the second BCS and wherein the first BCS has different signaling than the second BCS.

15. The method of claim 11, wherein communicating the BCS capability comprises an indication of the highest BCS supported by the base station.

16. The method of claim 11, wherein communicating the BCS capability comprises an indication of all BCS values supported by the base station.

17. The method of claim 11, wherein communicating the BCS capability comprises an indication that the base station supports a portion of a pre-defined plurality of BCS values.

18. A non-transitory computer readable media comprising computer-executable instructions that, when performed by one or more computer processing components, cause the one or more computer processing components to perform operations comprising:
communicating, to a first UE, a bandwidth combination set (BCS) capability;
receiving, from the first UE, one or more carrier aggregation (CA) capability messages from the first UE; and
based on the one or more CA capability messages, establishing a CA session by allocating a plurality of component carriers to the first UE.

19. The non-transitory computer readable media of claim 18, wherein the BCS capability comprises a first BCS and a second BCS, the first BCS being different than the second BCS, and wherein at least one parameter of the first BCS is different than the second BCS, the at least one parameter comprising a channel bandwidth or a signaled information element.

20. The non-transitory computer readable media of claim 19, wherein communicating the BCS capability comprises an indication of the highest BCS supported by the base station.
